(19) United States
(12) Patent Application Publication
(10) Pub. No.: US 2007/0067811 A1
(43) Pub. Date: Mar. 22, 2007

(54) Information processing apparatus and control method for the information processing apparatus

(76) Inventor: Takeshi Tajima, Hamura-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/520,660

(22) Filed: Sep. 14, 2006

(30) Foreign Application Priority Data
Sep. 20, 2005 (JP) 2005-272560

(51) Int. Cl. H04N 7/18; H04N 7/16

(52) U.S. Cl. 725/81; 725/62

(57) ABSTRACT

According to one embodiment, an information processing aparatus including a function of performing dial-up access to a server computer through a radio base station forming a radio service area in a predetermined geographic area, includes a monitoring unit configured to monitor whether or not the processing aparatus is placed in a radio service area to which the processing aparatus belongs when dial-up access is performed successfully, and an automatic log-off unit configured to forcibly terminate use of the processing aparatus when the monitoring unit detects that the processing aparatus departs from the service area.

### CROSS-REFERENCE TO RELATED APPLICATIONS

This application is based upon and claims the benefit of priority from prior Japanese Patent Application No. 2005-272560, filed Sep. 20, 2005, the entire contents of which are incorporated herein by reference.

### BACKGROUND

1. Field

One embodiment of the invention relates to a security technique which is appropriate to apply, for instance, to a notebook-sized personal computer easy to carry.

2. Description of the Related Art

In recent years, deskwork in an office has been performed by using a personal computer generally.

Recently, many offices have laid wireless LANs therein; connected personal computers to the wireless LANs without using any cable at their own conveniences and each staff of the office has become possible to simply take in necessary data from a shared file server, etc.

In the personal computers, there are a variety of types such as a desktop-type and a notebook-sized, so each notebook-sized personal computer has been extremely enhanced its performance. And, for instance, it is easy to house the notebook-sized personal computer in a drawer of a desk and a locker, so that the number of users adopting the notebook-sized personal as tools for the deskwork has increased.

Meanwhile, as for the notebook-sized personal computer, running a large risk of a theft such that it is carried away by an outsider is unavoidable. Nowadays in which the capacity of storage as well as the performance of the notebook-size personal computer have been enhanced, storing a large volume of important data has lost much of its novelty now. Therefore, it is needed to take account of sufficient measures for the case that the notebook-sized personal computer has been carried away by the outsider.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing an operation environment of an information processing aparatus regarding an embodiment of the present invention;

FIG. 2 is an exemplary perspective view showing an exterior appearance of the full face of the information processing aparatus of the embodiment;

FIG. 3 is an exemplary perspective view showing an exterior appearance in a state in which a display unit of the information processing aparatus of the embodiment is closed;

FIG. 4 is an exemplary block diagram showing a configuration of hardware of the information processing aparatus of the embodiment;

FIG. 5 is an exemplary block diagram showing a configuration of software of the information processing aparatus of the embodiment;

FIG. 6 is an exemplary view exemplifying an input screen for logging on displayed on the information processing aparatus of the embodiment; and

FIG. 7 is an exemplary flowchart showing an operation procedure for restricting use at the outside of a predetermined area by the embodiment.

### DETAILED DESCRIPTION

Various embodiments according to the invention will be described hereinafter with reference to the accompanying drawings. In general, according to one embodiment of the invention, an information processing aparatus including a function of performing dial-up access to a server computer through a radio base station forming a radio service area in a predetermined geographic area, includes a monitoring unit configured to monitor whether or not the processing aparatus is placed in a radio service area to which the processing aparatus belongs when dial-up access is performed successfully, and an automatic log-off unit configured to forcibly terminate use of the processing aparatus when the monitoring unit detects that the processing aparatus departs from the service area.

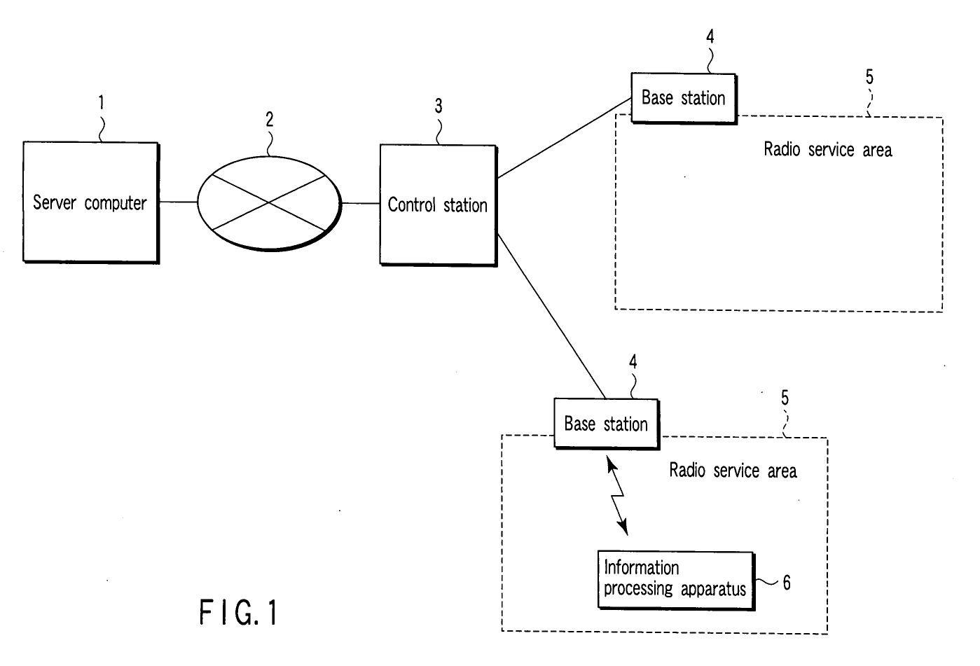

FIG. 1 shows the operation environment of the information processing aparatus regarding the one embodiment of the present invention. Here, it is presumed, for instance, that an information processing aparatus 6 is a notebook-sized personal computer which is provided for each staff of an enterprise. To provide the personal computer to each staff, it is defined that which base station 4 makes the personal computer be operable only under the control by the defined base station 4 and the information about the defined base station 4 is registered in a server computer 1 together with user identification information.

Each base station 4 forms radio service areas 5, respectively, to make radio communication with mobile stations. The processing aparatus 6 has a function to execute a radio communication with the base station 4, as a mobile station. A control station 3 houses each base station 4 to relay to a public line network 2. The server computer 1 is connected to the line network 2.

The information processing aparatus 6 can use dial-up access to the server computer 1 in logging on. The request for the dial-up access is transmitted to the server computer 1 via the base station 4. Upon receiving the request, the server computer 1 checks a user name and a password, and in addition to this, further checks whether or not the base station 4 which has relayed the transmission of the request coincides with a base station 4 defined to enable operating the processing aparatus 6. If all of the user names, passwords and base stations 4 are coincident with one another, the server computer 1 then replies an authentication establishment of the dial-up access.

The processing aparatus 6 which has received the reply of the authentication establishment carries on with monitoring whether or not the processing aparatus 6 itself is placed within the radio service area 5 to which it belongs after completing the dial-up access to the server computer 1 after logging on. The monitoring does not need to perform an actual data transmission/reception to/from the base station 4 forming the service area 5. And it may determine that the processing aparatus 6 departs from the service area 5 when an electric field intensity of a radio signal from the base station 4 reaches a level not more than a prescribed level, or that it departs form the service area 5 when handoff occurs. Upon detecting the departing from the service area 5, the processing aparatus 6 logs off voluntarily and forcibly.

That is, the processing aparatus 6 becomes possible to operate only under the predetermined base station 4, and in other words, the use at the outside of the service area 5 formed by the prescribed base station 4 is subjected to be restricted.

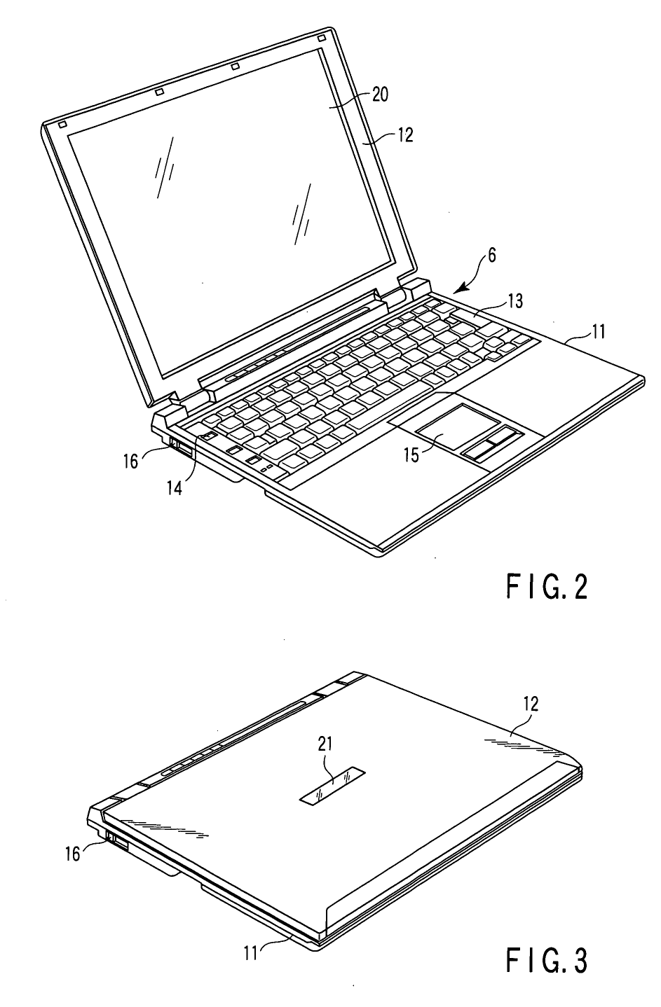

Next to this, referring to FIG. 2 and FIG. 3, the configuration of the information processing aparatus 6 will be set forth. As mentioned above, the processing apparatus (hereinafter referred to as a computer) 6 is composed as the notebook-sized personal computer. FIG. 2 is a perspective view when viewed from the front side of the computer 6 in a state where its display unit is opened.

The computer 6 consists of a computer main body 11 and a display unit 12. The display unit 12 has a built-in display device consisting of a liquid crystal display (LCD) 20, and the display screen of the LCD 20 is positioned at the almost the center of the display unit 12.

The display unit 12 is supported by the computer main body 11 and attached rotatably between an opening position at which the upper surface of the main body 11 is exposed and a closing position at which the upper surface thereof is covered. The main body 11 has a thin box-shaped housing, and a keyboard 13, a power button 14 to turn on/off the main body 6 and a touch pad 15 are disposed on the upper surface of the housing. The main body 11 has a communication device built-in.

A wireless communication switch 16 is disposed on the left side surface of the main body 11. The communication switch 16 is an operation switch to permit or inhibit an execution of a radio communication. The communication switch 16 is set to one state of a first state allowing executing the radio communication and a second state inhibiting executing the radio communication. With setting the communication switch 16 to the second state, it becomes possible to prevent the radio communication from being executed at a place, for instance, such as a hospital where the use of electric waves is restricted.

FIG. 3 is a perspective view showing the exterior appearance of the computer 6 in the state in which the display unit 12 is closed. A sub-display 21 is arranged on the rear surface of the display unit 12. The sub-display 21 displays information, etc. indicating, for example, the electric field intensity of the radio signal from a base station. Owing to the sub-display unit 21, a user can confirm whether or not the current position of the computer 6 is within the communication service area even in the state in which the display unit 12 is closed.

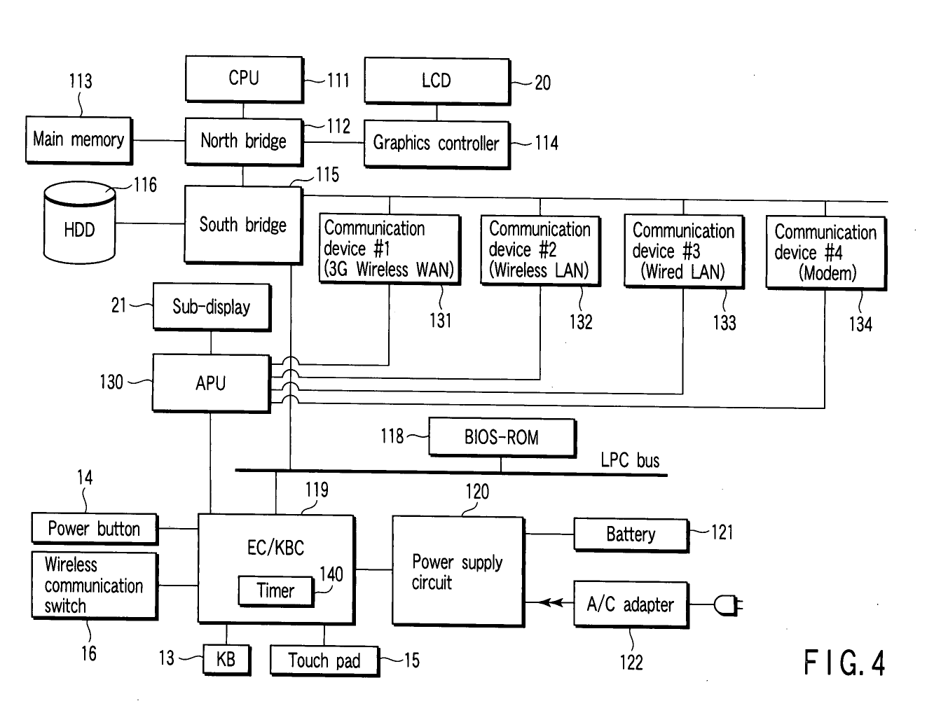

FIG. 4 shows an example of the hardware configuration of the computer 6.

The computer 6 includes a CPU 111, a north bridge 112, a main memory 113, a graphics controller 114, a south bridge 115, a hard disk drive (HDD) 116, a flash basic input output system (BIOS)-ROM 118, embedded controller/keyboard controller (EC/KBC) IC 119, a power supply circuit 120, an auxiliary processor unit (APU) 130, communication devices 131-134, etc.

The CPU 111 is a main processor to control operations of the computer 6. The CPU 111 executes an operating system (OS) and a variety of application programs/utility programs which are loaded into the main memory 113 from the HDD 116. The CPU 111 also executes a BIOS stored in the flash BIOS-ROM 118. The BIOS is a program to control hardware.

The north bridge 112 is a bridge device to connect between a local bus of the CPU 111 and the south bridge 115. The north bridge 112 also has a function of executing communication with the graphics controller 114 via an accelerated graphics port (AGP) bus, etc. The north bridge 112 further has a main controller to control the main memory 113 built-in.

The graphics controller 114 is a display controller to control the LCD 20 used as a display monitor of the computer 6. The south bridge 115 is connected to a peripheral component interconnect (PCI) bus and to a low pin count (LPC) bus independently. The south bridge 115 also incorporates an IDE controller to control the HDD 116.

The EC/KBC 119 is a one-chip microcomputer in which an embedded controller to manage a power source and a keyboard controller to control the keyboard (KB) 13 and the touch pad 15, etc. The EC/KBC 119 cooperates with the power supply circuit 120 to turn on/off the computer 6 depending on the operations of the power button switch 14 by the user. The power supply circuit 120 uses an external power source to be supplied through a battery 121 or an AC adopter 122 to generate operation power to be supplied to each component of the computer 6. Even in a state in which the computer 6 is turned off, the power supply circuit 120 supplies the operation power to the EC/KBC 119. The EC/KBC 119 also detects the on/off of the communication switch 16 to transfer the fact to the BIOS.

The APU 130 has a function to monitor each operation of the communication devices 131-134. That is, the APU 130 is electrically connected to each communication devices 131-134 through serial buses (for example, SMBUS, USB, etc.) in a point-to-point manner and capable of communicating with each communication device 131-134 directly. The APU 130 determines whether or not each of the communication devices 131-134 is available, namely, whether or not each of the communication devices 131-134 is in an executable state of a communication with an external device via a wired or radio network by making communications with each communication device 131-134. The APU 130 also has a function of controlling the sub-display 21.

The communication device 131 is a radio communication device and executes radio communication with base station 4 in accordance with a radio communication specification such as a 3G Wireless LAN. The 3G wireless LAN is a wide radio network of a mobile phone network, etc. The communication device 132 is also a radio communication device and performs radio communication with an access point (AP) in accordance with the radio communication specification such as the Wireless LAN.

The communication devices 133 and 134 are wired communication devices each. The communication device 133 performs communication with the external device via a Wired LAN. The communication device 134 is composed, for instance, of a modem to conduct communication with the external device via a telephone network.

In succession, a software configuration to realize a restriction of the use at the outside of a specified area for the computer 6 having such a hardware configuration will be described with reference to FIG. 5.

An OS 301 is a basic program integrally control a resource management of the computer 6 and has a variety of modules including a dial-up service 301a to execute dial-up access to the server computer 1 and a communication driver 301b to drive and control each radio communication device.

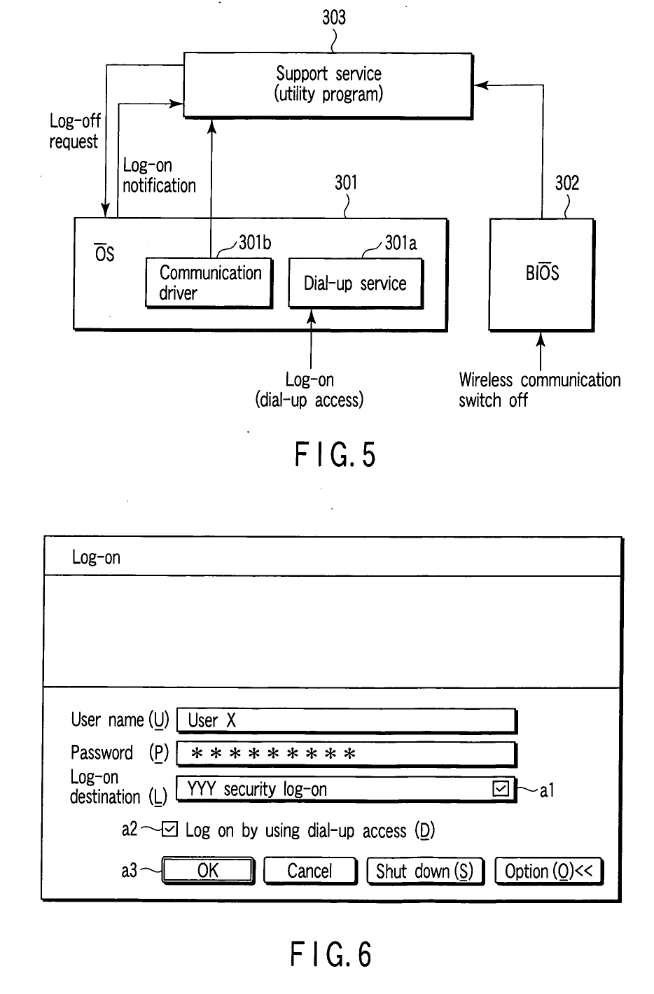

When the computer 6 logs on, the OS 301 outputs an input screen for log-on shown in FIG. 6. The user inputs the user name and password in the input screen, and checks a check box (a2) of “log on by using a dial-up access” as well as specifies the server computer 1 for authentication in a field (a1) of “log-on destination”.

In a state where the foregoing inputs have been performed, when an “OK” button is operated, the computer 6 tries to make dial-up access to the server computer 1 through the dial-up service 301a of the OS 301. Then, when the server computer 1 confirms the user name, password and relay base station 4 to reply the authentication establishment of the dial-up access, log-on is permitted and the permission is notified to a support service 303 that is a utility program.

The support service 303 is a resident-type program, and when the log-on is notified from the OS 301, it monitors whether or not the computer 6 has departed from the service area of the base station 4 to which the computer 6 has belonged at the time of the log-on as well as whether or not the handoff has occurred. The support service 303 monitors whether the communication switch 16 has not been switched to off through the BIOS 302 (which is stored in the flash BIOS-ROM 118).

If the support service 303 detects that the computer 6 has departed from the service area 5 of the base station 4 to which the computer 6 has belonged in a log-on time or that the communication switch 16 has switched to off, the support service 303 transmits a log-off request to the OS 301 as measurements to the case in which, for instance, the computer 6 has carried away by the outsider. Thereby, the limitation of the use at the outside of the predetermined area is achieved.

Even when an authorized user has erroneously carried away the computer 6 at the outside of the service area, the computer 6 is forcibly logged off. In this case, the user may return back to the predetermined area and log on again. In the case of having a suspend/resume function, the computer 6 becoming to be suspended in a log-on state, for such a situation, the computer 6 may log-off immediately in a suspension time and may log-off at timing when it is detected that the computer 6 has moved to the outside of the service area or it has switched off after a resume.

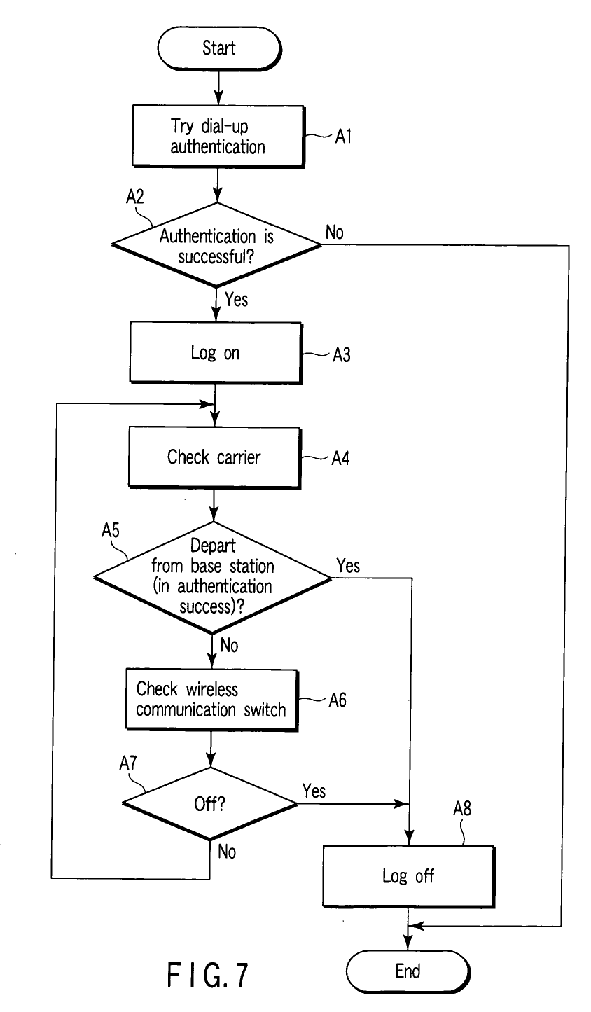

FIG. 7 is a flowchart showing an operation procedure to restrict the use of the computer 6 at the outside of the prescribed area.

The computer 6 firstly tries the dial-up access to the server computer for authentication 1 (block A1). If the authorized user (who can input a correct user name and password) is present in the predetermined area, the authentication is completed successfully (yes in block A2), so that the computer 6 is permitted to log on (block A3).

When logged on, the computer 6 checks by itself whether the self has departed from the service area of the base station 4 in logging on (block A4,A5) and also checks whether or not the wireless communication switch 16 has switched off (block A6,A7).

The result of this checking having checked the fact that the computer 6 is at the outside of the service area of the base station in logging on (Yes in block A5) or that the communication switch 16 is switched off (Yes in block A7), the computer 6 is forcibly logged off at that moment (block A8).

As mentioned above, the computer 6 in the embodiment is controlled so as to become operable only within the predetermined area of the base station 4. That is to say, it is achieved that the computer 6 is restricted to be used at the outside of the predetermined area.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing aparatus including a function of performing dial-up access to a server computer through a radio base station forming a radio service area in a predetermined geographic area, comprising:
a monitoring unit configured to monitor whether or not the processing aparatus is placed in a radio service area to which the processing aparatus belongs when dial-up access is performed successfully; and
an automatic log-off unit configured to forcibly terminate use of the processing aparatus when the monitoring unit detects that the processing aparatus departs from the service area.

2. The information processing aparatus according to claim 1, wherein the monitoring unit monitors an electric field intensity of a radio signal from the radio base station forming the service area.

3. The information processing aparatus according to claim 1, wherein the monitoring unit determines that the processing aparatus departs from the service area when handoff occurs.

4. The information processing aparatus according to claim 1, further comprising a switch to turn on/off radio communication control between the radio base station,
wherein the log-off unit forcibly terminates the use of the processing aparatus when the switch is turned off.

5. The information processing aparatus according to claim 1, further comprising a suspend/resume function,
wherein the log-off unit forcibly terminates the use of the processing aparatus in a suspension time.

6. The information processing aparatus according to claim 1, further comprising a suspend/resume function,
wherein the log-off unit forcibly terminates the use of the processing aparatus when the monitoring unit detects that the processing aparatus departs from the service area after resume.

7. A control method for an information processing aparatus including a function of performing dial-up access to a server computer through a radio base station forming a radio service area in a predetermined geographic area, comprising:
monitoring whether or not the processing aparatus is placed in a radio service area to which the processing aparatus belongs when dial-up access to a predetermined server computer is performed successfully; and
forcibly terminating use of the processing aparatus when the monitoring means detects that the processing aparatus departs from the service area.

8. The control method according to claim 7, wherein the information processing aparatus includes a switch for turn on/off radio communication control between the radio base station, and
the terminating forcibly terminates the use of the processing aparatus when the switch is turned off.

9. The control method according to claim 7, wherein the information processing aparatus includes a suspend/resume function, and
the terminating forcibly terminates the use of the processing aparatus in a suspension time.

10. The control method according to claim 7, wherein the information processing aparatus includes a suspend/resume function, and
the terminating forcibly terminates the use of the processing aparatus when the monitoring means detects that the processing aparatus departs from the service are after resume.
